(19) United States
(12) Patent Application Publication
(10) Pub. No.: US 2026/0259730 A1
(43) Pub. Date: Sep. 3, 2026

(54) COMPILER TO DETERMINE BOUNDS OF AN ATTENTION MASK FOR TILE-LEVEL COMPUTATION SKIPPING

(71) Applicant: NVIDIA Corporation, Santa Clara, CA (US)

(72) Inventors: Mihir Bipin Shah, San Jose, CA (US); Rajnish Aggarwal, San Jose, CA (US)

(21) Appl. No.: 19/206,908

(22) Filed: May 13, 2025

Related U.S. Application Data
(60) Provisional application No. 63/764,739, filed on Feb. 28, 2025.

(51) Int. Cl. G06F 9/30

(52) U.S. Cl. CPC G06F 9/30032; G06F 9/30029; G06F 9/30038; G06F 9/30069

(57) ABSTRACT

In various examples, apparatuses, systems, processors, methods, and/or machine-readable mediums are used to generate bounding functions for a mask predicate, and to generate instructions to skip computation of values corresponding to one or more portions of an attention matrix masked by the mask predicate. In at least one embodiment, a compiler is used to analyze arbitrary and/or user-defined masks, and to generate bounding functions that may be used by an executing kernel to identify which tiles of an attention matrix can be skipped at runtime.

### CROSS-REFERENCE TO RELATED APPLICATION

This application claims the benefit of U.S. Provisional Application No. 63/764,739, filed on Feb. 28, 2025, the contents of which are hereby incorporated by reference in their entirety.

### BACKGROUND

Some machine learning techniques, such as transformer-based deep learning models, utilize attention (e.g., Multi-Head Attention (MHA), single-head attention, Luong attention, self-attention, and/or others) to capture relationships between different tokens and store those relationships (e.g., as attention scores or attention weights) in an attention matrix. Attention is useful for capturing relationships between tokens (e.g., in a sequence), and masks may be applied to control these relationships. For example, attention masks may be applied to attention matrices to control which relationships between tokens should be ignored, such as causal masks that cause future tokens to be ignored. Such masks introduce sparsity, by allowing masked-off tokens to be skipped from computation, which can improve computational performance. In instances where computations are performed for a group of attention scores between tokens (e.g., a tile) rather than for individual scores, an entire masked off group of attention scores may be skipped from computation. However, unmasked or partially masked groups cannot be skipped from computation without potentially negatively affecting the results, and methods of identifying groups of masked tokens may be improved.

### SUMMARY

Embodiments of the present disclosure relate to a compiler to determine bounds of an attention mask for tile-level computation skipping. Some processors, such as graphics processing units (GPUs), process items of an attention matrix in groups, referred to as tiles. Such processors either skip or process a particular tile in its entirety. Systems and methods are disclosed that utilize a compiler that analyzes mask predicates at compile time, and generates bounding functions to automate the process of determining which tiles in an attention matrix can be skipped at runtime. A mask predicate is a comparison or a set of comparisons combined by one or more logical operators that define a mask used to determine which items in the attention matrix are to be included in further processing or analysis. A comparison consists of individual expressions (referred to as elements), combined with a logical, comparison, or arithmetic operator (e.g., >=). For example, calculation of attention scores masked by a mask defined by a mask predicate may be skipped from computation because the masked attention scores will not be used in subsequent processing or analysis.

In contrast to conventional systems, the systems and methods disclosed may use a compiler to automate the generation of bounding functions (e.g., affine and/or monotonic bounding functions) for mask predicates at compile time, allowing masked tiles to be skipped at runtime. This approach may reduce runtime overhead and/or be used to support arbitrary mask predicates (e.g., arbitrary user-defined mask predicates).

### BRIEF DESCRIPTION OF THE DRAWINGS

The present systems and methods for a compiler to determine bounds of an attention mask for tile-level computation skipping are described in detail below with reference to the attached drawing figures, wherein:

FIG. 1 illustrates an example system to process one or more mask predicates to be used by one or more neural networks, in accordance with at least one embodiment;

FIG. 2 illustrates example compiler components to use an arbitrary mask predicate to generate instructions to cause one or more masked portions of an attention matrix to be skipped by at least one attention component (e.g., at least one attention head), in accordance with at least one embodiment;

FIG. 3 is an illustration of an example attention matrix masked in accordance with an example mask predicate, in accordance with at least one embodiment;

FIG. 4 is a flow diagram illustrating the method that uses an arbitrary mask predicate to generate one or more kernels to be performed by one or more GPUs, in accordance with at least one embodiment;

FIG. 5 is a flow diagram illustrating the method of using the helper function to analyze the parsed comparisons and generate the upper and lower bounds based on those comparisons, in accordance with at least one embodiment;

FIG. 6 is a flow diagram illustrating the method of generating bounding functions using upper and lower bounds generated by the helper function, in accordance with at least one embodiment;

FIG. 7 illustrates an example including a processor and modules, in accordance with at least one embodiment, according to at least one embodiment;

FIG. 8 is a block diagram illustrating a driver and/or runtime including one or more libraries to provide one or more application programming interfaces (APIs), according to at least one embodiment;

FIG. 9A is a block diagram of an example generative language model system suitable for use in implementing at least some embodiments of the present disclosure;

FIG. 9B is a block diagram of an example generative language model that includes a transformer encoder-decoder suitable for use in implementing at least some embodiments of the present disclosure;

FIG. 9C is a block diagram of an example generative language model that includes a decoder-only transformer architecture suitable for use in implementing at least some embodiments of the present disclosure;

FIG. 10 is a block diagram of an example computing device suitable for use in implementing at least some embodiments of the present disclosure; and

FIG. 11 is a block diagram of an example data center suitable for use in implementing at least some embodiments of the present disclosure.

### DETAILED DESCRIPTION

Systems and methods are disclosed related to a compiler to determine bounds of an attention mask for tile-level computation skipping.

As mentioned herein, some machine learning techniques, such as transformer-based deep learning models, utilize attention (e.g., MHA, single-head attention, Luong attention, self-attention, and/or others) to capture relationships between different tokens and store those relationships (e.g., as attention scores or attention weights) in an attention matrix. The attention matrix may be stored in a data structure such as a multi-dimensional array, a two-dimensional array, matrix, tree, table or represented by any other data structure type. The attention matrix may be calculated by an attention component, such as an attention head and/or other attention mechanism. A mask predicate, which is a comparison or a set of comparisons (e.g., individual elements combined by one or more logical operators and/or one or more arithmetic operators and/or one or more comparison operators) that define a mask, may be used to mask the attention matrix. The mask determines which items in the attention matrix are to be included in further processing or analysis. For example, the attention component may skip calculation of attention scores masked by a mask defined by a mask predicate, which will cause the processed attention values corresponding to the skipped attention scores to be zero. By way of a non-limiting example, the attention component may set the values of the skipped attention scores to a large negative number which will cause corresponding attention weights to be zero. By way of another non-limiting example, the attention weights may be calculated by applying one or more softmax functions to the attention scores.

One or more processors, such as one or more parallel processing units, like one or more GPUs, may process more than one item of an attention matrix at a time. For example, such processor(s) may process tiles of the attention matrix, either skipping or processing each tile in its entirety. While the processor(s) may skip any entirely masked tiles without affecting the results (e.g., a resultant context vector), the processor(s) cannot skip any unmasked or partially masked tiles without potentially negatively affecting the results. By way of non-limiting examples, such negative effects may include irrelevant results (e.g., results that focus on irrelevant or misleading information included in the input tokens), ambiguous results (e.g., results that provide a vague or incoherent summary of the input tokens, which may make it difficult for the model to derive meaningful insights or predictions), and/or results that encode a task mismatch (e.g., results that encode features not aligned with task requirements, which may result in poor performance or incorrect outputs).

Some current methods of determining which tiles can be skipped evaluate a mask predicate for each item in an attention matrix, determining which tiles are completely masked off, and encode this information in a matrix that an MHA kernel may use to lookup which tiles in the attention matrix to skip. However, this method can be costly due to the need for item-wise evaluation of large attention matrices and/or memory loads in the MHA kernel, which can slow down processing. Other methods involve one or more programmers manually specializing a kernel (e.g., a MHA kernel) for a particular mask, such as causal mask, defined by a mask predicate. This approach sacrifices generality and requires programmer(s) to implement.

At least one embodiment includes a compiler that analyzes one or more mask predicates (e.g., one or more arbitrary user-defined mask predicates), and generates, at compile time, a set of bounding functions to be used by executable code output by the compiler, such as kernel (e.g., a Compute Unified Device Architecture (CUDA) kernel), at runtime to identify which (valid or unmasked) tiles of an attention matrix are within a valid region bounded by the set of bounding functions, and which (invalid or masked) tiles are outside the valid region and are to be skipped. The compiler, therefore, performs tasks previously performed manually by a programmer, such as analysis of mask behavior and configuring the kernel based on the analysis. The set of bounding functions may be implemented as monotonic functions, which define the left-most and right-most valid columns for each row in the attention matrix. Monotonicity allows for determining the left-most and right-most valid column for a tile's span of rows, without evaluating the function at each row of the tile. The set of bounding functions allow the kernel to determine which tiles can be skipped at runtime, based on the valid region defined by the mask.

The inputs to the compiler may include one or more mask predicates, and the outputs of the compiler may include the kernel and/or the set of bounding functions (e.g., left and right bounding functions), which are used by the kernel to identify which tiles to skip during runtime. A mask predicate, which is a comparison or a set of comparisons (e.g., combined by one or more logical operators and/or one or more arithmetic operators) that define a mask, may be used to mask the attention matrix. The mask predicate is a logical and/or mathematical comparison or a set of such comparisons (e.g., individual elements combined by one or more logical operators and/or one or more comparison operators and/or one or more arithmetic operators) defining valid and invalid items in the attention matrix. In at least one embodiment, the mask predicate is a function of a variable row that represents a row in the attention matrix, and a variable col that represents a column in the attention matrix. Locations of cells or items within the attention matrix may be expressed by values of the variables row and col (e.g., as (row, col)). The mask predicate indicates whether an item at (row, col) is valid. The compiler may parse the mask predicate into one or more comparisons. If the compiler parses the mask predicate into multiple comparisons, the comparisons may be linked or joined by one or more logical operations, such as one or more logical AND operations and/or one or more logical OR operations. The compiler may use a predefined expression grammar to express the mask predicate and/or the comparison(s). In at least one embodiment, if a portion of a mask predicate cannot be parsed into a comparison, the compiler will generate bounding functions based on any comparisons the compiler is able to parse combined with conservative bounds for portions that cannot be parsed.

The compiler may then use one or more helper functions to derive and generate a set of affine bounds (e.g., lower and upper bounds) on an element within the comparison(s) obtained or parsed from the mask predicate. For example, if e>=0, the compiler may compute lower and upper affine bounds on e, L(r,c) and U(r,c), and select U(r,c) since it is more conservative in a greater-than comparison. Then, the compiler may transform U(r,c)>=0 into a bound on c (which is the left or right bound) trivially, since U(r,c) is affine.

In at least one embodiment, the comparisons of the mask predicate can contain non-affine operations that, through the use of interval arithmetic, may be represented by affine bounds, such as where the operations are non-decreasing functions w.r.t the r,c variables. The helper function(s) is/are used to derive lower and upper bounds for each element within each comparison (e.g., expression) in the mask predicate, where the mask predicate can be broken into one or more comparisons. In at least one embodiment, the helper function(s) generate(s) an affine lower bound and an affine upper bound for individual elements of a comparison. In some embodiments, the upper bound is selected to conservatively bound a valid region defined by the comparison. The compiler then derives the affine bounds generated by the helper function(s) to be used to form the left and right bounding functions for the entire mask defined by the mask predicate. The generated left and right bounding functions may be monotonic (non-decreasing) to ensure that the first row of a tile of the attention matrix yields the left-most column and the last row of that tile yields the right-most column in the valid region as defined by the mask predicate, for that row of tiles. The compiler then configures the kernel to use the left and right bounding functions to determine a range of tiles to compute per row at runtime. For example, the compiler may configure the kernel to calculate a value of the left bounding function at that first row, and then round that value down to a first nearest tile to identify a column in the current row before which tiles can be skipped on the left. Similarly, the compiler may configure the kernel to calculate a value of the right bounding function at that last row, and then round that value up to a second nearest tile to identify a column in the current row after which tiles can be skipped on the right.

In some examples, the machine learning model(s) (e.g., deep neural networks, language models, LLMs, SLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software. In at least one embodiment, the compiler may be packaged and/or otherwise implemented as microservice that analyzes a mask predicate (e.g., an arbitrary user-defined mask predicate), and generates, at compile time, a set of bounding functions to be used by executable code output by the compiler, at runtime, to identify which tiles of an attention matrix are within a valid region bounded by the set of bounding functions, and which tiles are outside the valid region and are to be skipped. In at least one embodiment, the executable code may be packaged and/or otherwise implemented (e.g., by the compiler) as a microservice, such an inference microservice.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, SLM, VLM, MMLM, diffusion model, transformer model, NeRF, DNN, etc.) and/or the image database hosted on the local and/or remote servers using one or more APIs—such as, without limitation, REST APIs. In at least one embodiment, the executable code output by the compiler (based at least in part on one or more mask predicates) may be used to process data received and/or to generate data output by a talking or smart kiosk application. For example, the executable code may implement one or more neural networks (e.g., one or more LM, one or more LLMs, one or more SLMs, one or more VLMs, one or more MMLMs, one or more transformer, etc.) used by the talking or smart kiosk application to communicate with one or more users.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, SLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used. In at least one embodiment, the executable code output by the compiler (based at least in part on one or more mask predicates) may be used to process data received and/or to generate data output by a gaming application. For example, the executable code may implement one or more neural networks (e.g., one or more LM, one or more LLMs, one or more SLMs, one or more VLMs, one or more MMLMs, one or more transformer, etc.) used by the gaming application to communicate with one or more users.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, SLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used. In at least one embodiment, the executable code output by the compiler (based at least in part on one or more mask predicates) may be used to process data received and/or to generate data output by a video conferencing application. For example, the executable code may implement one or more neural networks (e.g., one or more LM, one or more LLMs, one or more SLMs, one or more VLMs, one or more MMLMs, one or more transformer, etc.) used by the video conferencing application to communicate with one or more users.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, SLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers). In at least one embodiment, the executable code output by the compiler (based at least in part on one or more mask predicates) may be used to process data received and/or to generate data output by a robotics application. For example, the executable code may implement one or more neural networks (e.g., one or more LM, one or more LLMs, one or more SLMs, one or more VLMs, one or more MMLMs, one or more transformer, etc.) used by the robotics application to facilitate communication with one or more users and/or one or more robotic devices. By way of a non-limiting example, the neural network(s) may generate instructions to control one or more functions and/or movements of the robotic devices.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time. In at least one embodiment, the executable code output by the compiler (based at least in part on one or more mask predicates) may be used to process data received and/or to generate data output by an IVI system and/or an IX application. For example, the executable code may implement one or more neural networks (e.g., one or more LM, one or more LLMs, one or more SLMs, one or more VLMs, one or more MMLMs, one or more transformer, etc.) used by the IVI system and/or the IX application to facilitate communication with one or more users and/or the vehicle. By way of a non-limiting example, the neural network(s) may generate instructions to control one or more functions or operations of the IVI system and/or the IX application.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), one or more small language models (SLMs), vision language models (VLMs), multi-modal language models (MMLMs), etc.), and/or other types of machine learning models.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

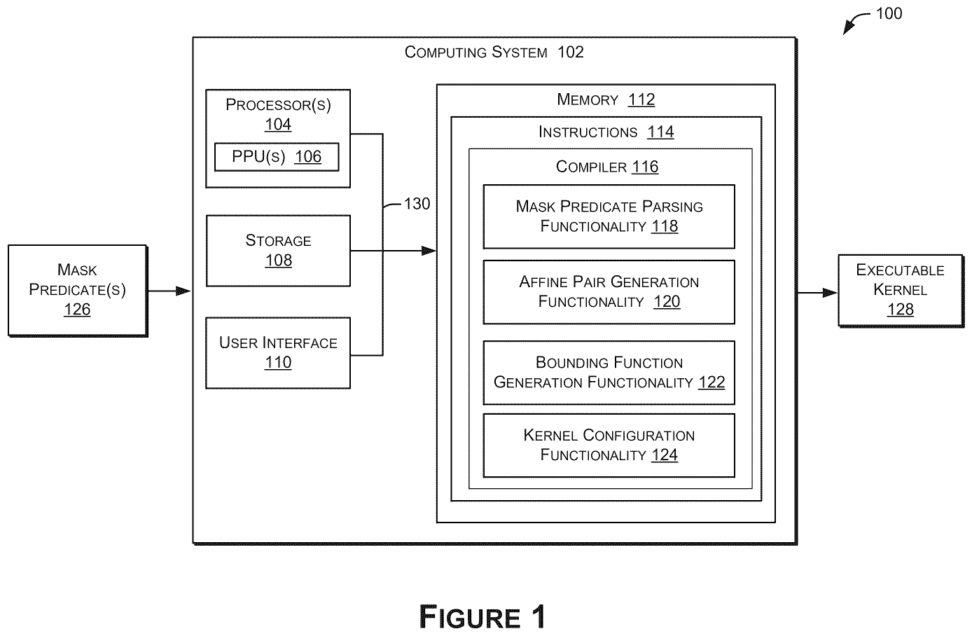

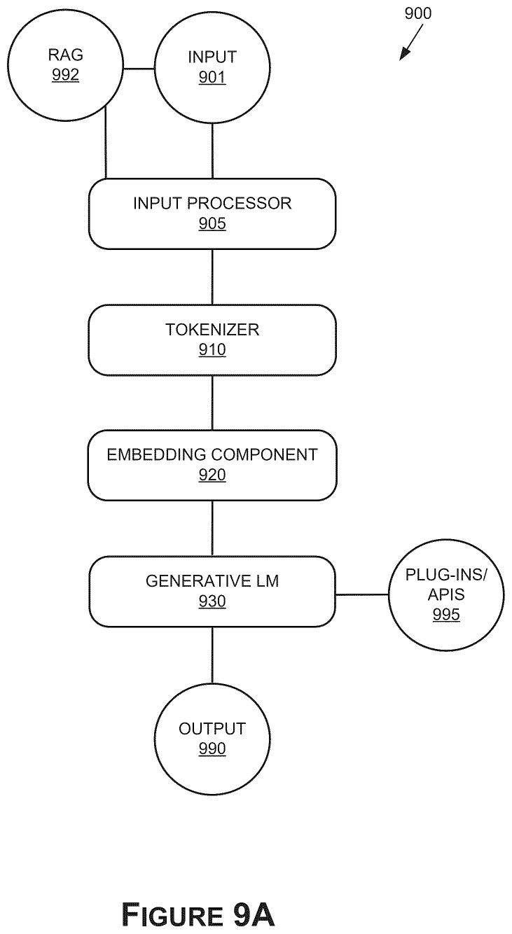

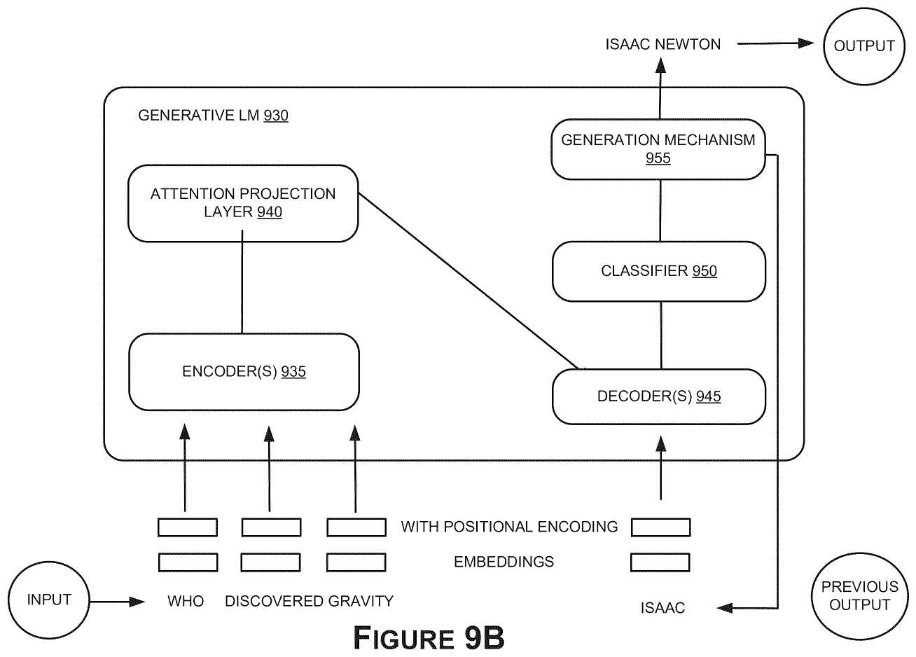

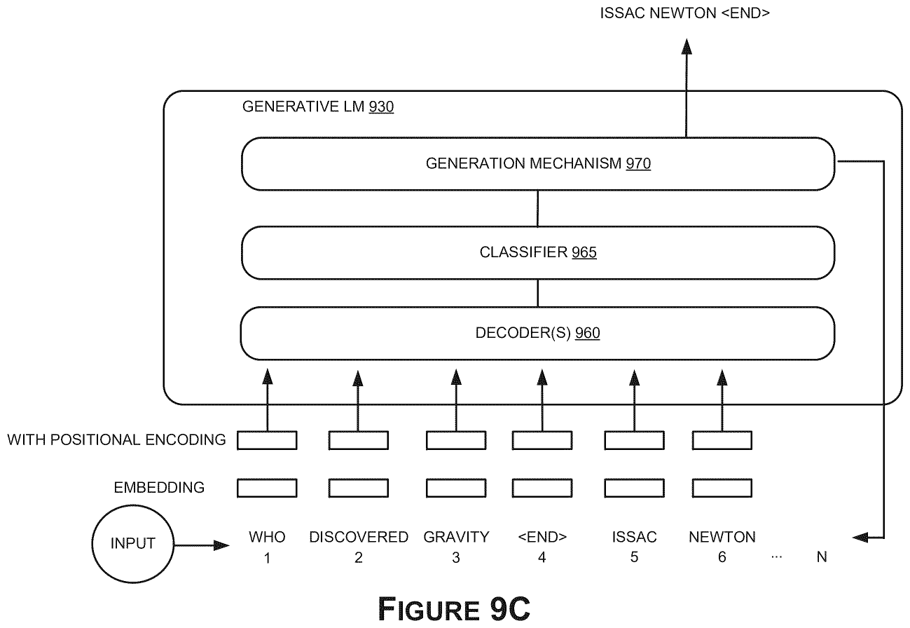

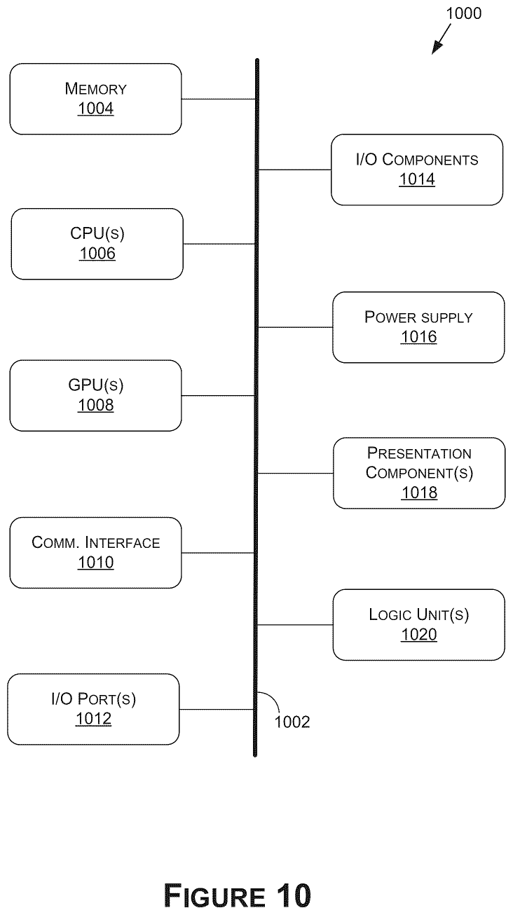

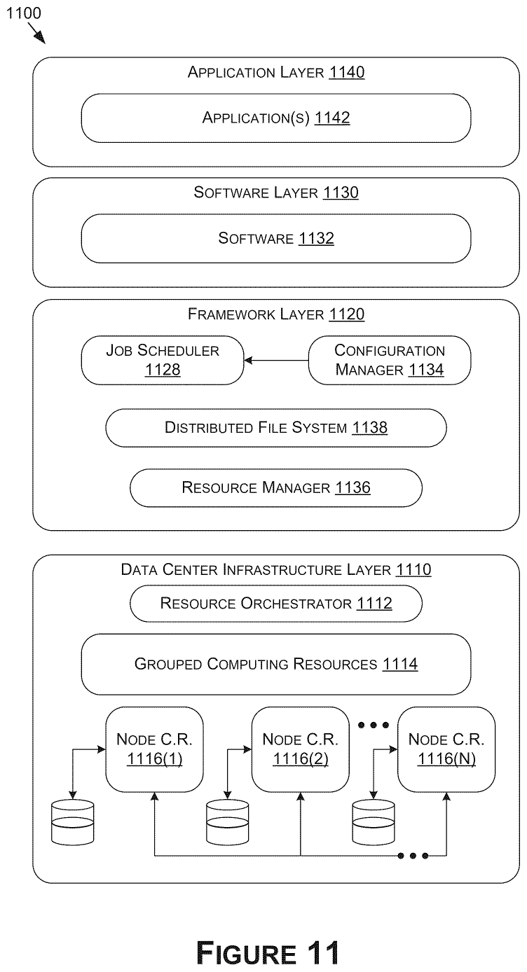

With reference to FIG. 1, FIG. 1 is an example system 100 to process one or more mask predicates 126 to be used by one or more neural networks (e.g., one or more transformer-based deep learning models), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories. For example, in some embodiments, the system and methods described herein may be implemented using one or more generative language models (e.g., as described in FIGS. 9A-9C), one or more computing devices or components thereof (e.g., as described in FIG. 10), and/or one or more data centers or components thereof (e.g., as described in FIG. 11).

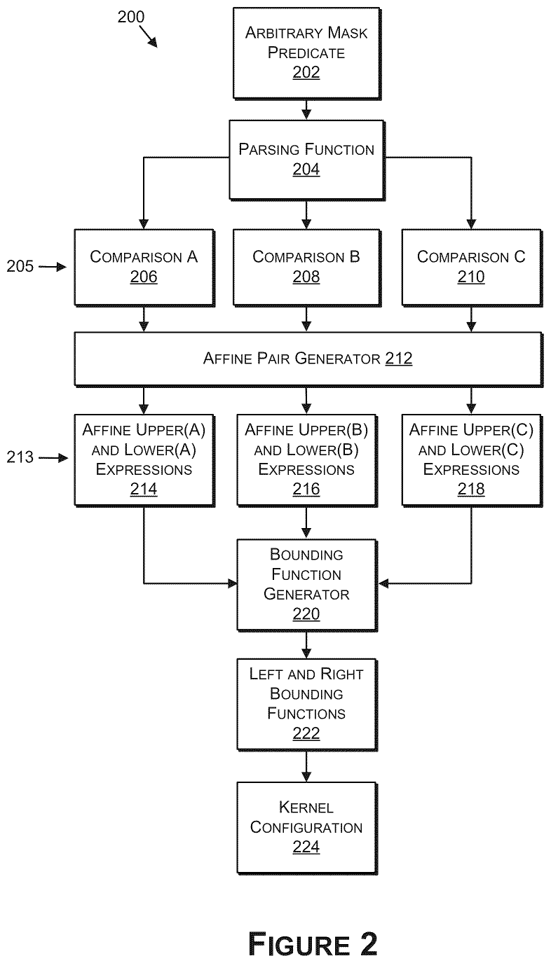

The system 100 includes a computing system 102 that includes one or more processors 104 connected to a user interface 110 and/or memory 112 via one or more connections 130, such as a bus and/or one or more other types of connections. In at least one embodiment, the computing system 102 implements at least a portion of any system(s) depicted in and/or described with respect to FIGS. 2-11. In at least one embodiment, the computing system 102 is implemented using at least a portion of any system(s) depicted in and/or described with respect to FIGS. 2-11.

The memory 112 (e.g., one or more non-transitory machine readable media) may store instructions 114, and the processor(s) 104 may be responsible for executing the instructions 114 and/or managing the overall operation of the computing system 102. In at least one embodiment, the processor(s) 104 may include one or more parallel processing units (PPU(s)) 106 (e.g., one or more graphics processing units (GPU(s))) to perform parallel processing operations. The processor(s) 104 may include circuitry that includes one or more circuits that perform at least a portion of the instructions 114 stored in the memory 112. The PPU(s) 106 may include one or more massively parallel PPU(s), and/or the like. In at least one embodiment, massively parallel PPU(s) refer to a collection of one or more PPUs, or any suitable processing units, which may be utilized to perform various processes in parallel. The processor(s) 104 may be implemented, for example, using a main CPU complex, one or more microprocessors, one or more microcontrollers, one or more data processing units (“DPU(s)”), one or more arithmetic logic units (“ALU(s)”), one or more accelerators, and/or the like. In at least one embodiment, at least a portion of at least one of the processor(s) 104 is used to implement at least a portion of any system(s) depicted in and/or described with respect to FIGS. 2-11. In at least one embodiment, at least a portion of at least one of the processor(s) 104 is implemented using at least a portion of any system(s) depicted in and/or described with respect to FIGS. 2-11.

In at least one embodiment, the computing system 102 includes and/or has access to storage 108 that provides persistent storage for data and/or instructions used by the computing system 102. For example, the processor(s) 104 of the computing system 102 may be connected to the storage 108 by the connection(s) 130. The storage 108 may include various forms of non-volatile memory, such as one or more solid-state drives (SSDs), one or more hard disk drives (HDDs), and/or others. In at least one embodiment, the storage 108 is used to implement at least a portion of any system(s) depicted in and/or described with respect to FIGS. 2-11. In at least one embodiment, the storage 108 is implemented using at least a portion of any system(s) depicted in and/or described with respect to FIGS. 2-11.

The user interface 110 may facilitate interaction between users and the computing system 102. The user interface 110 may include input devices (e.g., a keyboard, a mouse, a touch screen, and/or others) and/or output devices (e.g., a display screen) to allow users to input data and/or receive information (e.g., feedback) from the computing system 102. The user interface 110 may include a display device (not shown) that a user may use to view information generated and/or displayed by the computing system 102. The user may use the user interface 110 to enter user input (e.g., one or more prompts) into the computing system 102. The user interface 110 may communicate (e.g., wirelessly) with a user device (e.g., a cellular telephone, a laptop computer, a tablet, and/or the like) and may receive user input from the user device. In at least one embodiment, the user interface 110 is used to implement at least a portion of any system(s) depicted in and/or described with respect to FIGS. 2-11. In at least one embodiment, the user interface 110 is implemented using at least a portion of any system(s) depicted in and/or described with respect to FIGS. 2-11.

The memory 112 may store the instructions 114 and/or various functionalities required for the operation of the system 100. By way of additional non-limiting examples, the memory 112 (e.g., one or more non-transitory processor-readable medium) may be implemented, for example, using volatile memory (e.g., dynamic random-access memory (“DRAM”)) and/or nonvolatile memory (e.g., a hard drive, a solid-state device (“SSD”), and/or the like). In at least one embodiment, at least a portion of the memory 112 implements at least a portion of any system(s) depicted in and/or described with respect to FIGS. 2-11. In at least one embodiment, at least a portion of the memory 112 is implemented using at least a portion of any system(s) depicted in and/or described with respect to FIGS. 2-11.

The memory 112 stores instructions 114 that, when executed by the processor(s) 104, implement a compiler 116 to generate executable code, such as an executable kernel 128, by performing mask predicate parsing functionality 118, affine pair generation functionality 120, bounding function generation functionality 122, kernel configuration functionality 124, and/or one or more other types of functionalities. The kernel 128 may implement attention (e.g., MHA, single-head attention, Luong attention, self-attention, and/or others) to capture relationships between different tokens (e.g., in a sequence) and store those relationships (e.g., as attention scores or attention weights) in an attention matrix. The attention matrix may be calculated by an attention component of the kernel 128, such as an attention head and/or other attention mechanism. The mask predicate(s) 126 may be used to mask one or more of these relationships within one or more attention matrices. The attention component (e.g., at least one of the attention heads of MHA) may be a component of one or more neural networks, such as one or more transformer-based learning models, one or more generative language models (e.g., a generative language model described with respect to FIGS. 9A-9C), one or more RNNs with Attention, one or more CNNs with Attention, one or more Encoder-Decoder models, one or more Vision Transformers (ViTs), one or more Graph Neural Networks (GNNs) with Attention, one or more Sequence-to-Sequence (Seq2Seq) models, one or more Neural Machine Translation (NMT) models, one or more text summarization models, one or more image captioning models, one or more speech recognition models, one or more conversational artificial intelligence (AI) models (e.g., a chatbot), and/or one or more other machine learning processes.

For example, the kernel 128 may obtain a set of tokens as input. In at least one embodiment, the kernel 128 may generate the set of tokens from source data (e.g., a sequence). For example, if the source data is text, the kernel 128 may divide the text into smaller portions, such as words, subwords, characters, groups of words, groups of word parts, etc. By way of another non-limiting example, byte pair encoding (BPE) may be used (e.g., by the kernel 128) to obtain the tokens based at least in part on the source data. Next, the tokens may be used (e.g., by the kernel 128) to generate embedded tokens, which are numerical representations of the tokens (e.g., vectors) that are mapped to the tokens they represent. In some embodiments, positional encodings that encode the position of tokens within the source data (e.g., within a sequence) are added to the embedded tokens (e.g., by the kernel 128). After the kernel 128 obtains the embedded tokens with or without positional encodings as input data, the kernel 128 may use one or more attention components (e.g., attention heads or other attention mechanisms) to process the input data. Each attention component generates at least one attention matrix for the input data. For example, a particular attention component may derive Query (Q), Key (K), and Value (V) vectors from the input data (e.g., using learned linear transformations), and calculate an attention matrix of attention scores using at least two of the Q, K, and V vectors (e.g., a matrix of dot products between the Q vector and all of the K vectors). As mentioned herein, the particular attention component may skip calculation of attention scores masked by a mask defined by a mask predicate, and may set the values of the skipped attention scores to a large negative number. The particular attention component may scale the attention scores and/or convert the attention scores to probabilities (e.g., using one or more softmax functions), referred to as attention weights, that indicate importance of each embedded token relative to a current embedded token being processed. If the attention component set the values of the skipped attention scores to a large negative number, converting the attention scores to probabilities (e.g., by applying the softmax function(s) to the attention scores) will cause attention weights corresponding to skipped attention scores to be zero. The particular attention component may use the attention weights to obtain a context vector by computing a weighted sum of the V vectors (e.g., by multiplying each V vector by its corresponding attention weight, and the results may be summed to produce the context vector). The particular attention component may output the context vector, which captures relevant information from the embedded tokens, drawing attention to the most important ones.

The kernel 128 may implement one or more components, such as one or more feed-forward neural networks, one or more layer normalization processes, one or more subsequent transformer layers, an output layer (e.g., which generates one or more output tokens and/or performs one or more other operations to generate output), and/or one or more other components that receive and use the context vector(s) output by the attention component(s). For example, the kernel 128 may cause the processor(s) 104 to use the context vector(s) to perform one or more other tasks, such as natural language processing (NLP), machine translation, text summarization, sentiment analysis, question answering, named entity recognition (NER), computer vision, image classification, object detection, image generation, speech processing, speech recognition, speech synthesis, implementing recommendation systems, providing personalized recommendations, implementing biomedical applications, protein structure prediction, genomic sequence analysis, financial analysis, algorithmic trading, fraud detection, gaming, implementing an AI, and/or to perform one or more other tasks, such as any of the tasks described herein.

The source data may include text (e.g., natural language), audio, image(s), video(s), and/or one or more other types of data. The embeddings may be obtained using any method of encoding the source data, such as using Word2Vec, Global Vectors for Word Representation (GloVe), FastText, a Bidirectional Encoder Representations from Transformer (BERT), an Embeddings from Language Model (ELMo), one or more transformer-based models (e.g., GPT, RoBERTa), and/or others. The embeddings may capture semantic information and/or other types of information present in the source data. The attention components(s) implemented by the kernel 128 may implement at least a portion of a machine learning process such as a transformer, one or more generative language models (e.g., the generative language model described with respect to FIGS. 9A-9C), a RNN with Attention, a CNN with Attention, an Encoder-Decoder model, a ViT, a GNNs with Attention, a Seq2Seq model, a NMT model, a text summarization model, an image captioning model, a speech recognition model, a conversational AI model (e.g., a chatbot), and/or one or more other machine learning processes that may use at least one masked attention matrix. The attention components(s) implemented by the kernel 128 may implement one or more language models (LM(s)), which may include one or more large language models (LLM(s)), one or more small language models (SLM(s)), one or more vision language models (VLM(s)), one or more multi-modal language model (MMLM(s)), one or more vision-language-action (VLA) models, etc.

The mask predicate parsing functionality 118 (e.g., if performed by the processor(s) 104) may interpret the mask predicate(s) 126 and/or extract one or more comparisons (also referred to herein as comparison(s)) from the mask predicate(s) 126. The mask predicate(s) 126 may be provided by a user and/or an automated process. For example, the mask predicate(s) 126 may be user-defined and/or arbitrary.

The affine pair generation functionality 120 (e.g., if performed by the processor(s) 104) may derive affine expressions that upper and lower bound expressions within the comparison(s) obtained from the mask predicate(s) 126. An affine expression represents a linear function that may be expressed as f(x)=ax+b. A particular one of the mask predicate(s) 126 may include one or more comparisons that include one or more affine expressions, and/or one or more non-affine expressions (e.g., floor division, and/or others). For example, the following mask predicate includes three comparisons combined by logical AND operators (“&&”): (row−col>=0) && (row−col<=127) && col<=512. When expressed in a canonical form with an expression on left-hand side and zero on right-hand side, (row−col>=0) && (row−col−127 <=0) && col−512<=0, there are three elements. In this case, they are all already affine. Even if a comparison includes at least one non-affine expression, affine upper and lower bounding expressions may be determined for that expression.

The affine pair generation functionality 120 may include and/or use a helper function that receives an individual element of a comparison e as input, and outputs a pair of affine expressions (also referred to herein as upper and lower bounds) in terms of row, col that bound the expression e (e.g., in form a*row+b*col+c). For example, the mask predicate above includes three elements. Thus, the helper function may return an upper bound and a lower bound for each of these three elements. When rearranged in terms of a bound on col, the helper function may define implicit left and right bounds for each comparison, such as col>=0 and col<=S31 1, respectively. In this example, the variable S represents a sequence length associated with the source data. The implicit left bound (e.g., col>=0) may be used if a comparison lacks a left bound, and the implicit right bound (e.g., col<=S−1) may be used if a comparison lacks an upper bound.

A comparison e>=0 with element e that has lower and upper affine bounds L(r,c), U(r,c) can be represented as U(r,c)>=0, and a comparison e<=0 with element e that has lower and upper affine bounds L(r,c), U(r,c) can be represented as L(r,c)<=0. Because L,U are affine, the affine pair generation functionality 120 can obtain a bound on the variable col by solving the lower and upper affine bounds L(r,c), U(r,c) for the variable col. For example, the comparison (row−col<=127) can be canonicalized in e<=0 form as row−col−127<=0. Then, since e=row−col−127 is itself affine, L(r,c)=e. Then, the L(r,c)<=0 form is just row−col−127<=0. Then, the compiler 116 may solve the lower affine bound L(r,c) for the variable col to obtain col>=row−127. Since when solved for col, there is no right bound in this comparison, the implicit right bound (e.g., col<=S−1) may be used. The helper function may then return the left and right bounds generated.

The bounding function generation functionality 122 (e.g., if performed by the processor(s) 104) may generate monotonic functions that define a valid region of an attention matrix. The bounding function generation functionality 122 may combine the upper and lower bounds output by the affine pair generation functionality 120 for the comparison(s) to generate left and right bounding functions (also referred to herein as left and right bounds). The bounding function generation functionality 122 may generate left and right bounds for a single comparison, and/or multiple comparisons combined by one or more logical operations (referred to as a recursive case).

The kernel configuration functionality 124 (e.g., if performed by the processor(s) 104) may use the bounding functions to configure executable code (e.g., the executable kernel 128) that determines which groups of attention scores between tokens (e.g., tiles) of the attention matrix can be skipped from computation (e.g., by an attention head) during runtime.

The computing system 102 may receive the mask predicate(s) 126, which may be provided by a user through the user interface 110. In at least one embodiment, the mask predicate(s) 126 is/are each a logical expression that defines valid and invalid items in an attention matrix. In at least one embodiment, the mask predicate(s) 126 is/are not restricted to predefined patterns, like causal masks, and may include one or more non-affine operations. In at least one embodiment, the mask predicate(s) 126 may include one or more masks defined manually by a user. The mask predicate(s) 126 may be a user customized expression defining masking conditions to be implemented by one or more attention component (e.g., one or more attention heads to perform MHA operations) performed by one or more neural networks, such as deep learning models. The mask predicate(s) 126 may be composed of comparisons and logical operations (AND/OR) involving row and column indices, and the mask predicate(s) 126 can include various arithmetic operations. The mask predicate(s) 126 may be characterized as being arbitrary such that the mask predicate(s) 126 can be any logical and/or mathematical expression defined by the user, without being restricted to predefined or standard patterns like causal masks.

The executable kernel 128 is executable code generated by the compiler 116 within the computing system 102, and executes attention operations (e.g., MHA operations in deep learning models), utilizing the mask predicate(s) 126 as described herein. The executable kernel 128 (e.g., one or more functions, such as CUDA kernels, performed by one or more GPUs) is to utilize the bounding functions derived from the mask predicate(s) 126 to determine which groups of embedded attention scores between tokens (e.g., tiles) the masked attention matrix indicates can be skipped from computation during runtime, thereby improving computational performance and/or reducing computer resource utilization. The outputted executable kernel 128 helps ensure that only computations with respect to unmasked embedded tokens, as defined by the mask predicate(s) 126, are performed.

FIG. 2 illustrates example compiler components 200 to use an arbitrary mask predicate 202 to generate instructions to cause one or more masked portions of an attention matrix to be skipped by at least one attention component (e.g., at least one attention head), in accordance with at least one embodiment. The arbitrary mask predicate 202 may be received from a user and/or an automated process, and is in turn provided to a parsing function 204, which interprets the arbitrary mask predicate 202 and breaks the arbitrary mask predicate 202 down into individual comparisons 205, such as example comparison A 206, example comparison B 208, and example comparison C 210. While the three comparisons A-C 206-210 have been illustrated in FIG. 2, the comparisons 205 may include any number of comparisons. The arbitrary mask predicate 202 may be one of the mask predicate(s) 126 of FIG. 1.

Returning to FIG. 2, the comparisons 205 are individual comparisons that when combined mathematically, logically, or otherwise define the arbitrary mask predicate 202. Thus, the parsing function 204 may be characterized as dividing or parsing the arbitrary mask predicate 202 into multiple comparisons consisting of individual elements, each representing a distinct condition that either or both must be satisfied by positions or locations within the attention matrix (e.g., to be occupied by attention scores within a valid region of the attention matrix). The comparisons 205 need not be directly parsable from the arbitrary mask predicate 202 but may instead be derived mathematically, logically, or otherwise based upon the arbitrary mask predicate 202. The parsing function 204 may generate as many comparisons as needed to represent the arbitrary mask predicate 202 and alternative embodiments may have more or less comparisons than those depicted in FIG. 2. The parsing function 204 may be performed by the mask predicate parsing functionality 118 of FIG. 1.

In some embodiments, a formalized grammar is utilized to provide a structured way to represent the arbitrary mask predicate 202, enabling the compiler 116 to parse the arbitrary mask predicate 202 into a form that can be analyzed to generate bounding functions. Non-limiting examples of the grammar may include one or more of the following expressions:
Value=int|shape_tensor,
Variable=row|col,
ArbitraryOpndOp=add|subtract,
ValueOpndOp=multiply|divide|minimum|maximum,
CompareOp=less_than|greater_than|equal_to|not_equal_to|less_than_or_equal|greater_than_or_equal, and
LogicalOp=and|or.

Operations represented by ArbitraryOpndOp are linear (and therefore affine), and operations represented by ValueOpndOp may be non-linear and not affine. As mentioned above, a mask predicate includes one or more comparisons. Thus, the grammar may be used to define a mask as Mask=Predicate. The grammar may be used to define a comparison as Predicate=(LogicalOp Predicate Predicate)|(CompareOp Expr Expr), which means the recursive type Predicate equals a logical operator flanked by a pair of predicates (e.g., “&&” flanked by ((row−col>=−4) and (row−col<=2)), or a comparison operator flanked by a pair of expressions (e.g., “>=” flanked by “row−col” and “−4)) (a comparison, as referred to throughout). An expression may be defined recursively as Expr=Value|Variable|(ArbitraryOpndOp Expr Expr)|(ValueOpndOp Expr Value). For example, a dilated sliding window attention pattern ((row−col>=−4) && (row−col<=2) && ((row−col) % 2==0)) may be written using the grammar as (&& (&& (>=(−row col)−4) (<=(−row col) 2)) (==(% (−row col) 2) 0)).

The comparisons 205 are processed by an affine pair generator 212, which derives an affine pair, including affine upper and lower bounds, for each/every element(s) of the comparisons 205. The affine pair generator 212 may process the comparisons 205 derived from the arbitrary mask predicate 202 and generate affine upper and lower bounds for each individual element of each comparison, facilitating the creation of bounding functions that define valid regions within the attention matrix. A valid region includes items within the attention matrix that are not masked by a mask defined by the arbitrary mask predicate 202. By analyzing the expressions (e.g., defined by Expr in the grammar) included in the comparisons 205 (e.g., the comparison A 206, comparison B 208, and the comparison C 210), the affine pair generator 212 produces pairs of affine expressions 213 that bound the range of values for valid row and column indices. In the example illustrated in FIG. 2, the expressions 213 include affine upper A and affine lower A expressions 214 generated for each element of the comparison A 206, affine upper B and affine lower B expressions 216 generated for each element of the comparison B 208, and affine upper C and affine lower C expressions 218 generated for each element of the comparison C 210. The affine pair generator 212 utilizes interval arithmetic to bound non-linear operations, ensuring that the expressions 213 are linear expressions in terms of variables row and col. The affine pair generator 212 may be performed by the affine pair generation functionality 120 of FIG. 1.

A bounding function generator 220 utilizes the affine bounds defined by the expressions 213 to create monotonic left and right bounding functions 222. The left and right bounding functions 222 bound the valid region of the attention matrix, allowing a kernel configuration 224 (e.g., generated by the compiler 116 illustrated in FIG. 1) to determine which groups of embedded attention scores between tokens (e.g., tiles) can be skipped from computation by an attention component (e.g., an attention head) while performing one or more computations at runtime (e.g., while computing the attention scores). The bounding function generator 220 helps ensure that the left and right bounding functions 222 are monotonic to guarantee that the first row of the attention matrix yields the left-most column and the last row yields of the attention matrix the right-most column, which enables efficient group-level (e.g., tile-level) skipping during runtime. The bounding function generator 220 may be performed by the bounding function generation functionality 122 of FIG. 1.

The kernel configuration 224 integrates the monotonic left and right bounding functions 222 generated by the bounding function generator 220 into the executable kernel 128 depicted in FIG. 1 (e.g., MHA kernel). Referring to FIG. 2, the kernel configuration 224 configures the executable kernel 128 with the derived left and right bounding functions 222, enabling the executable kernel 128 to determine the range of groups (e.g., tiles) to be computed per row of the attention matrix at runtime. For example, the kernel configuration 224 may configure the executable kernel 128 to round down to the nearest tile with respect to the left bounding function to identify the column before which tiles can be skipped on left, and to round up to the nearest tile with respect to the right bounding function to identify the column after which tiles can be skipped on right. By utilizing the left and right bounding functions 222, the kernel configuration 224 ensures that the executable kernel 128 can skip computations for groups (e.g., tiles) outside the valid region defined by the arbitrary mask predicate 202. The kernel configuration 224 may be generated by the compiler 116 of FIG. 1. The kernel configuration 224 may be performed by the kernel configuration functionality 124 and may generate the executable kernel 128 of FIG. 1.

In at least one embodiment, any of the components of FIG. 2 may be implemented in at least a portion of any system(s) depicted in and/or described with respect to any of FIGS. 1 and 3-11.

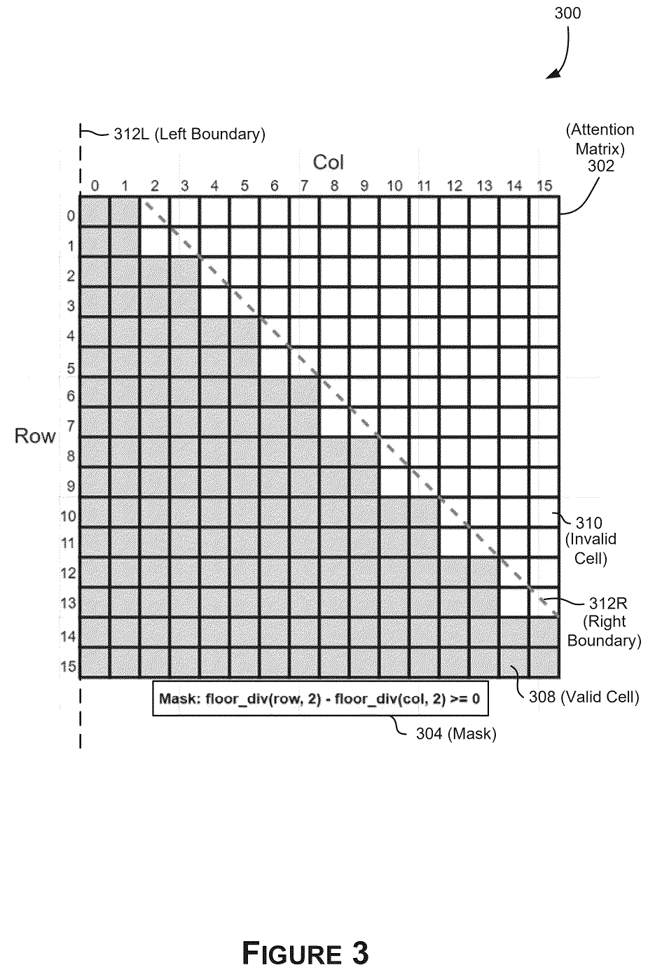

FIG. 3 is an illustration 300 of an example attention matrix 302 masked in accordance with an example mask predicate 304, in accordance with at least one embodiment. The mask predicate 304 may be expressed in terms of row and column indices, for example, represented by the variables row and col. The mask predicate 304 depicted in FIG. 3 is expressed as floor_÷(row, 2)−floor_÷|col, 2|≥0, which means whether each item in the attention matrix 302 is masked is determined by using floor division to divide its row number by two, and subtracting from that value a result of using floor division to divide its column number by two. For example, the mask predicate 304 would mask the item at row=10 and col=15 (referred to as cell or location (10,15)) in the attention matrix 302 because location (10,15) does not satisfy the mask predicate 304 (e.g., (10 div 2)−(15−div 2)=5-7=−2, which is not greater than or equal to zero). The mask predicate 304 would not mask the item at location (4,5) in the attention matrix 302 because location (4,5) satisfies the mask predicate 304 (e.g., (4 div 2)−(5−div 2)=2-2, which is equal to zero). The attention matrix 302 is a data structure that may be segmented into groups or tiles (which include a number of adjoining items or cells of the attention matrix), with each tile representing a block of computations (e.g., computation and/or application of corresponding attention scores). The attention matrix 302 is structured into rows and columns, with the mask predicate 304 applied to delineate valid and invalid regions within the attention matrix 302. The shaded region signifies the unmasked or valid region in which computations are to be performed, while the unshaded region indicates the masked or invalid region for which computation can be skipped.

Valid cells 308 may be the individual items that represent the relevance scores between tokens in a sequence that fall within the bounds defined by the mask predicate 304, ensuring that all of these cells satisfy the condition floor_÷(row, 2)−floor_÷(col, 2)≥0. Invalid cells 310 may be the individual items that represent the relevance scores between tokens in a sequence that lie outside the valid region, as determined by the mask predicate 304, and these cells do not contribute to determining the attention scores and can be skipped during computation. Left and right boundaries 312L and 312R are depicted as dashed lines, representing the boundary of a valid region which may include transitions between valid and invalid regions. The left and right boundaries 312L and 312R may be defined by the monotonic left and right bounding functions 222 (see FIG. 2).

The mask predicate 304 is processed by the compiler 116 (see FIG. 1) to generate monotonic left and right bounding functions 222 (see FIG. 2) that define the valid region. The compiler 116 (e.g., the affine pair generator 212 illustrated in FIG. 2) uses a helper function to derive the affine expressions 213 (see FIG. 2) for the elements involved (e.g., in the comparisons 205), ensuring that the left and right boundaries 312L and 312R are monotonic.

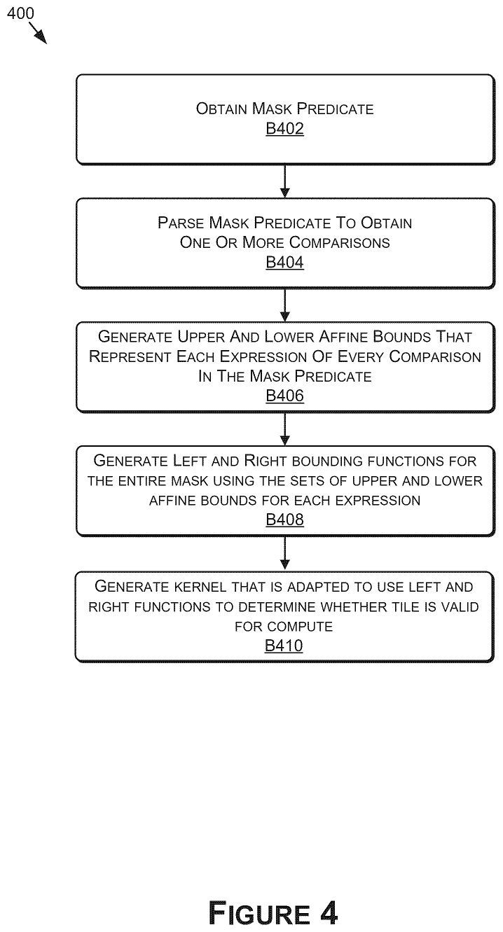

Now referring to FIG. 4, each block of a method 400, described herein, includes a computing process that may be performed using any combination of hardware, firmware, and/or software. For instance, various functions may be carried out using one or more processors executing instructions stored in one or more memories. The method 400 may also be embodied as computer-usable instructions stored on computer storage media. The method 400 may be provided by a standalone application, a service or hosted service (standalone or in combination with another hosted service), as a microservice via an application programming interface (API) or a plug-in to another product, to name a few. In addition, the method 400 is described, by way of example, with respect to the system of FIG. 1. However, this method 400 may additionally or alternatively be executed by any one system, or any combination of systems, including, but not limited to, those described herein. In at least one embodiment, at least a portion of the method 400 is performed by the compiler 116 (see FIG. 1).

FIG. 4 is a flow diagram illustrating the method 400 that uses an arbitrary mask predicate to generate one or more kernels (e.g., one or more CUDA kernels) to be performed by one or more GPUs, in accordance with some embodiments of the present disclosure. The method 400, at block B402, begins with obtaining a mask predicate. For example, at block B402, the compiler 116 may receive the mask predicate(s) 126 (e.g., from a user or automated process). For example, the user may provide the mask predicate to the compiler 116 via the user interface 110 (see FIG. 1). The mask predicate is a logical and/or mathematical expression that defines valid and invalid items within one or more attention matrices, based at least on one or more comparisons between row and column indices. The mask predicate may be expressed in a predefined grammar that allows the mask predicate to be recursively composed of or expressed as comparisons joined with logical AND/OR operations.

The method 400, at block B404, includes parsing the mask predicate into one or more comparisons. For example, at block B404, the mask predicate parsing functionality 118 may interpret the logical and/or mathematical structure of the mask predicate, breaking it down into individual comparison operations. Each comparison consists of an operator (e.g., less than, greater than) flanked by expressions on either side, which are further broken down into constants, and the variables row and col combined with arithmetic operations, such as addition, subtraction, multiplication, floor division, minimum, and maximum.

The method 400, at block B406, includes generating upper and lower affine bounds corresponding to each element of every comparison derived from the mask predicate in block B404. At block B406, the affine pair generation functionality 120 may use a helper function to derive linear expressions that bound any linear operations and/or any non-linear operations present in the mask predicate. The helper function is implemented to bound elements in a mask predicate handles both cases that include only linear expressions involving the variable row, variable col, and/or constants and cases including non-linear operations in their elements. Interval arithmetic and/or other techniques may be used to determine the upper and lower affine bounds for non-linear cases. For example, for a floor division operation, which is non-linear and not affine, the helper function may use interval arithmetic to derive upper and lower affine bounds for the quotient.

The method 400, at block B408, includes generating the left and round bounding functions for the entire mask using the sets of upper and lower affine bounds for each element (e.g., the left and right bounding functions 222). The left and right bounding functions bound the left-most and right-most valid columns for each row in the attention matrix, ensuring that the valid region is accurately bounded. At block B408, the compiler 116 may determine left and right bounding functions for base cases involving a single comparison, and/or recursive cases including two or more comparisons linked by at least one logical operator. The combination process may involve using the logical operations linking the comparisons to merge the left and right bounds determined for individual comparisons, applying rules such as taking the maximum of left bounds and the minimum of right bounds for logical AND operations. The bounding function generation functionality 122 may combine the upper and lower affine bounds for each element of each expression to produce the left and right bounding functions for the entire mask predicate at block B408.

The method 400, at block B410, includes generating a kernel (e.g., the executable kernel 128 illustrated in FIG. 1) that is adapted to use the left and right bounding functions determined at block B408 to determine whether a tile is valid for computation. For example, the compiler 116 (see FIG. 1) may configure the kernel at compile time, allowing the kernel to perform tile-level skipping based on the mask predicate. By way of a non-limiting example, at block B410, the kernel configuration 224 may configure the kernel to calculate a value of the left bounding function at a current row (e.g. the first row of a tile and/or the last row of a tile), and then round that value down to a first nearest tile to identify a column in the current row before which tiles can be skipped on left. Similarly, the kernel configuration 224 may configure the kernel to calculate a value of the right bounding function at the current row, and then round that value up to a second nearest tile to identify a column in the current row after which tiles can be skipped on right. Any tiles between the first and second nearest tiles are not skipped and their attention scores are calculated. The method 400 may terminate after block B410.

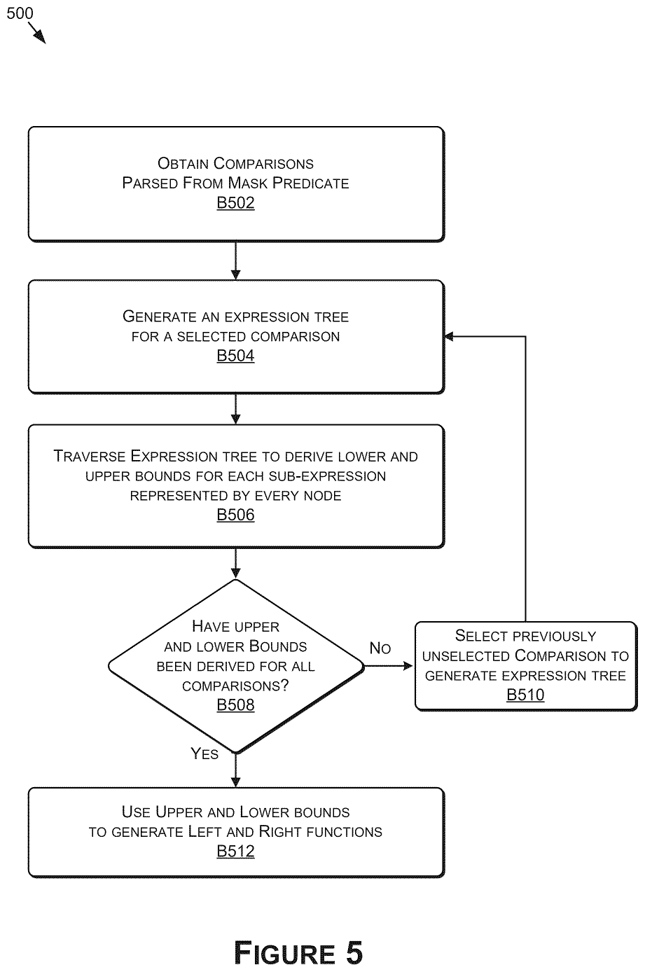

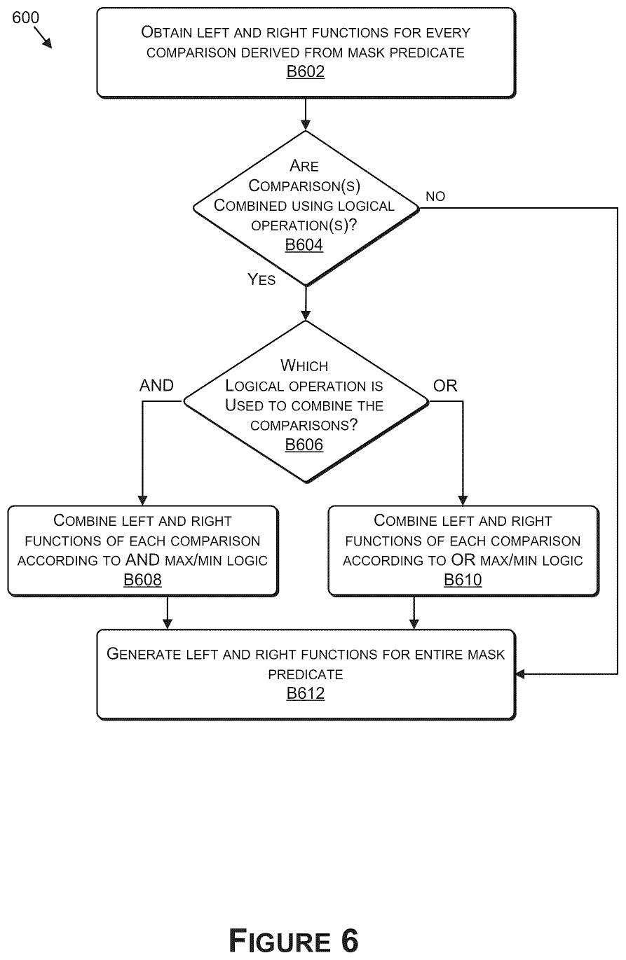

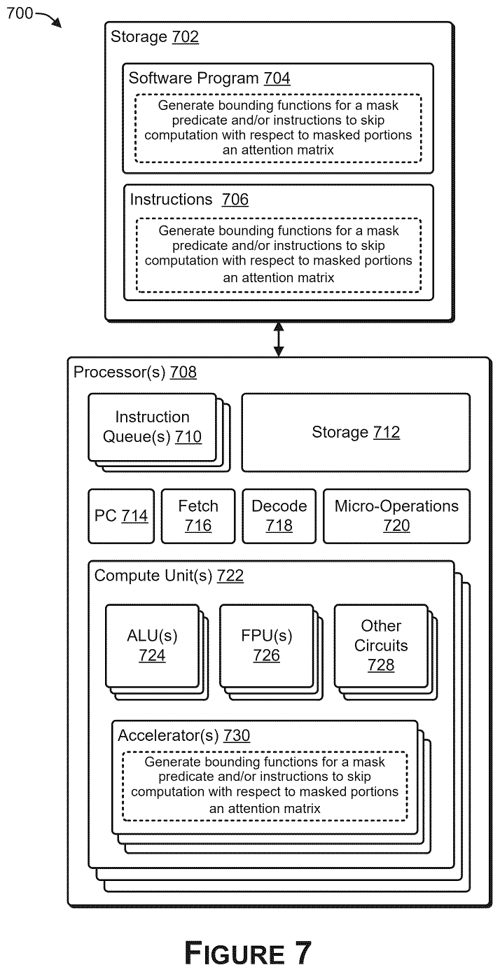

In at least one embodiment, any of the steps of FIG. 4 may be performed by the compiler 116 of FIG. 1 and/or the compiler components 200 of FIG. 2. In at least one embodiment, any of the steps of FIG. 4 may be optionally performed in the order depicted and/or performed in an alternative or simultaneous order with any other operations depicted in and/or described with respect to FIGS. 5 and 6. In at least one embodiment, any of the operations described with respect to FIG. 4 may be implemented using at least a portion of any system(s) depicted in and/or described with respect to FIGS. 7-11.

Now referring to FIG. 5, each block of a method 500, described herein, includes a computing process that may be performed using any combination of hardware, firmware, and/or software. For instance, various functions may be carried out using one or more processors executing instructions stored in one or more memories. The method 500 may also be embodied as computer-usable instructions stored on computer storage media. The method 500 may be provided by a standalone application, a service or hosted service (standalone or in combination with another hosted service), as a microservice via an application programming interface (API) or a plug-in to another product, to name a few. In addition, the method 500 is described, by way of example, with respect to the system of FIG. 1. However, this method 500 may additionally or alternatively be executed by any one system, or any combination of systems, including, but not limited to, those described herein.

FIG. 5 is a flow diagram illustrating the method 500 of using a helper function to generate upper and lower bounds based on elements in comparison(s), in accordance with some embodiments of the present disclosure. By way of a non-limiting example, the method 500 may be performed at blocks B406 and B408 of the method 400 (see FIG. 4). By way of a non-limiting example, the method 500 may be performed by the compiler 116, the affine pair generation functionality 120, and/or the bounding function generation functionality 122.

The method 500, at block B502, includes obtaining one or more comparisons (e.g., generated at block B404 of FIG. 4). The comparison(s) may have been generated or parsed based at least in part on a mask predicate (e.g., received from a user and/or an automated process). Each of the comparison(s) may include an operator (e.g., less than, greater than, less than or equal to, greater than or equal to, equal to, and/or others) flanked by expressions (elements). Each of the expressions is expressed in terms of one or more operands that include the variable row, the variable col, and/or one or more constants. The expressions include linear and non-linear arithmetic operations, such as addition, subtraction, multiplication, floor division, minimum, maximum, and the like, that operate on the operand(s).

The method 500, at block B504, includes generating an expression tree for each element of a comparison 205, where each internal node represents an operator and each leaf node represents an operand that is a constituent part of the expression from the comparison (e.g. an individual element of the comparison). The operators (such as addition, subtraction, multiplication, etc.) represented by the internal nodes may include the ArbitraryOpndOp and ValueOpndOp defined by the grammar described herein, and each leaf node represents an operand (such as the variable row, the variable col, or a scalar). The expression tree facilitates the derivation of lower and upper bound expressions (e.g., the expressions 213) for each element within the comparison, allowing the compiler 116 to process each operator and operand, applying interval arithmetic to derive the upper and lower bounds. The compiler 116 may encode the comparison using the grammar described, and this encoding may be used to generate the expression tree. The compiler 116 may perform block B504, which utilizes a helper function to systematically parse the comparison (e.g., read comparison encoded using the grammar) into a hierarchical structure (e.g., the expression tree).

The method 500, at block B506, includes traversing the expression tree to evaluate each element at each internal node, and derive lower and upper bounds for each of the elements. Traversing the expression tree, at block B506, includes analyzing operators and operands within the tree, applying interval arithmetic where necessary to handle non-linear operators, and combining bounds from child nodes to establish bounds for parent nodes. The traversal ensures that each element is accurately bounded, as well as monotonic, facilitating the generation of comprehensive upper and lower bounds for the individual elements of each comparison represented by the expression tree.

The method 500, at decision block B508, includes checking whether the upper and lower bounds have been derived for all of the comparison(s) obtained at block B502. If the decision at decision block B508 is “NO,” the upper and lower bounds have not been derived for all of the comparison(s), and the method 500, at block B510, includes selecting a previously unselected comparison, and returning to block B504 to generate an expression tree for that comparison. On the other hand, if the upper and lower bounds have been derived for all of the comparison(s), the decision at decision block B508 is “YES,” and the method 500, at block B512, includes using the upper and lower bounds to generate left and right bounding functions to be used by a kernel (e.g., the executable kernel 128) to determine whether a tile is valid for computation. The kernel uses the left and right bounding functions at runtime to skip tiles that fall outside the valid region, thereby enhancing computational efficiency. The kernel is configured at compile time, allowing the kernel to perform tile-level skipping based on a mask predicate. The method 500 may terminate after block B512.

In at least one embodiment, any of the blocks of FIG. 5 may be performed by the compiler 116 of FIG. 1 and/or the compiler components 200 of FIG. 2. In at least one embodiment, any of the operations of FIG. 5 may be optionally performed in the order depicted, and/or performed in an alternative or simultaneous order with any other operations depicted in and/or described with respect to FIGS. 4 and/or 6. In at least one embodiment, any of the operations of the method 500 may be implemented using at least a portion of any system(s) depicted in and/or described with respect to FIGS. 7-11.

Now referring to FIG. 6, each block of the method 600, described herein, includes a computing process that may be performed using any combination of hardware, firmware, and/or software. For instance, various functions may be carried out using one or more processors executing instructions stored in one or more memories. The method 600 may also be embodied as computer-usable instructions stored on computer storage media. The method 600 may be provided by a standalone application, a service or hosted service (standalone or in combination with another hosted service), as a microservice via an application programming interface (API) or a plug-in to another product, to name a few. In addition, the method 600 is described, by way of example, with respect to the system of FIG. 1. However, this method 600 may additionally or alternatively be executed by any one system, or any combination of systems, including, but not limited to, those described herein.

FIG. 6 is a flow diagram illustrating the method 600 of generating bounding functions using upper and lower bounds generated by the helper function, in accordance with some embodiments of the present disclosure. By way of a non-limiting example, the method 600 may be performed at block B408 of the method 400 (see FIG. 4) and/or block B512 of the method 500 (see FIG. 5). By way of a non-limiting example, the method 600 may be performed by the compiler 116, and/or the bounding function generation functionality 122.

The method 600, begins at block B602 with obtaining one or more pairs of left and right functions (e.g., derived from the expressions 213). For example, the bounding function generation functionality 122 may obtain a pair of left and right functions (e.g., derived from a pair of the expressions 213) for each comparison (e.g., each of the comparison(s) 205) derived from a mask predicate (e.g., the mask predicate 202). The pairs of expressions 213 may be generated using a helper function that processes each individual element within the comparison(s) to produce affine bounds for each of the elements, which are linear expressions in terms of row and column variables (e.g., the variables row and col).

The method 600, at decision block B604, includes determining whether the comparison(s) are combined by using a logical operation. At decision block B604, the compiler 116 may check if the mask predicate combines multiple comparisons using a logical AND operation or a logical OR operation. Logical operations may dictate how the left and right bounds are combined to form the final bounding functions (e.g., the left and right bounding functions 222). The decision at decision block B604 is “YES,” when the comparison(s) are combined using at least one logical operation. Otherwise, the decision at decision block B604 is “NO.”

If the comparisons do not use at least one logical operation (the decision at decision block B604 is “NO”), the left and right bounding functions may be considered to represent the entire mask predicate by the method 600 at block B612. At block B612, the compiler 116 may generate left and right functions that represent the entire mask predicate and all the parsed comparisons derived from the mask predicate. The left and right functions bound the left-most and right-most valid columns for each row in an attention matrix, ensuring that the valid region is accurately bounded.

If the comparison(s) do use a logical operation (the decision at decision block B604 is “YES”), the method 600, at decision block B606 identifies which logical operation is used to combine the comparison(s). For example, the method 600 may distinguish between logical AND operations and logical OR operations, which may determine at least in part how the left and right bounds are combined.

For any comparison(s) combined using a logical AND operation, the method 600, at block B608, may combine the left and right bounds of the comparison(s) according to AND max/min logic. For example, the compiler 116 may identify, as a left bounding function, a maximum of the left bounding functions and the compiler 116 may identify, as a right bounding function, a minimum of the a right bounding functions to ensure that the valid region is accurately bounded. The AND operation ensures that both conditions must be satisfied for a region to be considered valid.

For comparisons combined using a logical OR operation, the method 600, at block B610, may combine the left and right functions of each comparison according to OR max/min logic. For example, the compiler 116 may identify, as a left bounding function, a minimum of the left bounding functions, and the compiler 116 may identify, as a right bounding function, a the maximum of the right bounding functions to encompass all valid regions defined by the comparison(s). The OR operation allows for either condition to be satisfied for a region to be considered valid.

If the comparison(s) do use at least one logical operation, the compiler 116 may combine the left and right bounds of two or more of comparisons, and generate non-final or intermediate left and right bounds. The compiler 116 may recursively perform block B608 and/or block B610 to further combine such intermediate left and right bounds with the left and right bounds of another comparison or other intermediate left and right bounds. After block B608 and/or block B610 have been performed with respect to all of the comparisons combined using logical operators, the compiler 116 has obtained the left and right bounding functions.

After combining the left and right bounds, the method 600, at block B612 includes generating left and right bounding functions for the entire mask predicate (e.g., the left and right bounding functions 222) from the left and right bounding functions obtained according to the MAX/MIN logic used (e.g., at block B608 and/or block B610). The left and right bounding functions bound the left-most and right-most valid columns for each row in the attention matrix, ensuring that the valid region is accurately bounded.

In at least one embodiment, any of the steps of FIG. 6 may be performed by the compiler 116 of FIG. 1 and/or the compiler components 200 of FIG. 2. In at least one embodiment, any of the steps of FIG. 6 may be optionally performed as depicted in FIG. 6, and/or performed in an alternative or simultaneous order with any other operations depicted in and/or described with respect to FIGS. 4 and/or 5 In at least one embodiment, any of the operations of FIG. 6 may be implemented using at least a portion of any system(s) depicted in and/or described with respect to FIGS. 7-11.

FIG. 7 illustrates an example of a system 700 that can include software and hardware to generate bounding functions for a mask predicate, generate instructions to skip computation with respect to masked portions an attention matrix, and/or otherwise perform any of the operations described herein, according to at least one embodiment. System 700 can include storage 702 and processor(s) 708. Storage 702 can include, for example, memory, cache, or other storage described further herein. Storage 702 can be separate from processor(s) 708, or storage 702 can be included in processor(s) 708 (e.g., in storage 712). In at least one embodiment, software program 704 and/or instructions 706 can be stored in memory, cache, or other storage and provided to processor(s) 708 to cause one or more circuits of processor(s) 708 to perform operations described herein. In at least one embodiment, software program 704 and/or instructions 706 can be integrated into one or more circuits of processor(s) 708. Software program 704, which can be used to perform any of the operations described herein, may be stored on storage 702.

In at least one embodiment, software program 704 can include one or more software modules. In at least one embodiment, as used in any implementation described herein, unless otherwise clear from context or stated explicitly to contrary, a module refers to any combination of software logic, firmware logic, hardware logic, and/or circuitry configured to provide functionality described herein. In at least one embodiment, software is embodied as a software package, code and/or instruction set or instructions, and “hardware,” as used in any implementation described herein, includes, for example, singly or in any combination, hardwired circuitry, programmable circuitry, state machine circuitry, fixed function circuitry, execution unit circuitry, and/or firmware that stores instructions performed by programmable circuitry. In at least one embodiment, modules are, collectively or individually, embodied as circuitry that forms part of a larger system, for example, an integrated circuit (IC), system on-chip (SoC), and so forth. In at least one embodiment, a module performs one or more processes in connection with any suitable processing unit and/or combination of processing units, such as one or more CPUs, GPUs, GPGPUs, PPUs, and/or variations thereof including those further described herein.

In at least one embodiment, software program 704 can include a collection of software code, commands, instructions, or other sequences of text to instruct a computing device to perform one or more computational operations and/or invoke one or more other sets of instructions, such as API(s) or API function(s) or Instruction Set Architecture (ISA) level instructions, to be executed or otherwise performed. Instructions (e.g., hardware instructions) or microcode can involve ISA level instructions, which can include native ISA instructions or non-native ISA instructions. Software program 704 and/or instructions 706 (e.g., one or more modules) can be distributed among multiple processors that communicate over a bus, network, by writing to shared memory, and/or any suitable communication process such as those described herein.

In at least one embodiment, system 700 can include one or more instructions 706 that can, for example, provide one or more APIs and/or ISA instructions. In at least one embodiment, one or more APIs and/or ISA instructions can be used to cause neural network(s) to generate bounding functions for a mask predicate, generate instructions to skip computation with respect to masked portions an attention matrix, and/or otherwise perform any of the operations described herein. In at least one embodiment, one or more instructions 706 can be included in drivers and/or runtimes. In at least one embodiment, instructions 706 (e.g., including one or more APIs and/or ISA instructions) can include sets of software instructions that, if executed or otherwise performed, cause processor(s) 708 to perform one or more computational operations, such as any of the operations described herein. In at least one embodiment, one or more APIs and/or ISA instructions can be distributed or otherwise provided as a part of one or more instructions 706, runtimes, drivers, and/or any other grouping of software and/or executable code further described herein. In at least one embodiment, one or more APIs and/or ISA instructions can perform one or more computational operations in response to invocation by software program 704.

Processor(s) 708 may include any number of processors and any suitable processing unit and/or combination of processing units, such as, but not limited to, central processing units (“CPUs”), graphics processing units (“GPUs”), or other processors (including accelerators, field programmable gate arrays (FPGAs), graphics processors, parallel processors, GPGPUs, DPUs, and/or variations thereof including those further described herein), including any processors described herein, such as, but not limited to, processors in FIGS. 9A-11. In at least one embodiment, processor(s) 708 can retrieve or fetch instructions (e.g., one or more APIs and/or ISA instructions) from storage 702 using, for example, instruction fetch 716 (e.g., for an Instruction Fetch stage). Instructions can include instructions to generate bounding functions for a mask predicate, generate instructions to skip computation with respect to masked portions an attention matrix, and/or otherwise perform any of the operations described herein. In at least one embodiment, processor(s) 708 can include storage 712 and instruction queue 710 to store and queue instructions fetched from storage 702. In at least one embodiment, fetched instructions can be decoded by decode 718 to determine what operation should be performed by processor(s) 708 (e.g., in an Instruction Decode stage). In at least one embodiment, processor(s) 708 can fetch additional operands (data) that may be used for instructions, and operands can be stored, e.g., in registers or storage 712. In at least one embodiment, micro-operations 720 can perform operations on data stored in one or more registers or storage 712. For example, each step of instructions fetched by processor(s) 708 can be decomposed during execution so processor(s) 708 can execute instructions in steps through a series of micro-operations 720. In at least one embodiment, program counter (PC) 714 can hold an address for a next instruction and can be updated to point to the next instruction to be executed by processor(s) 708.

In at least one embodiment, processor(s) 708 can perform instructions (e.g., in an Execution stage). For example, processor(s) 708 can perform an operation specified by the instructions, such as an arithmetic operation, a logical operation, or a data transfer. In at least one embodiment, compute unit(s) 722 can execute instructions to perform any of the operations described herein. In at least one embodiment, compute unit(s) can include ALU(s) 724 (Arithmetic Logic Units), which may be used for performing arithmetic and logical operations. In at least one embodiment, compute unit(s) can include FPU(s) (Floating Point Units) 726, which may be used for performing floating-point calculations. In at least one embodiment, other circuits 728 can be used to perform other operations, such as vector and/or scalar operations. In at least one embodiment, accelerator(s) 730 can include one or more matrix multiplication accelerators, one or more parallel processing units (PPUs), such as GPUs, or any other accelerator or processor further described herein. In at least one embodiment, software program 704 can utilize one or more APIs and/or ISA instructions to perform various computing operations with accelerator(s) 730, such as matrix multiplication, arithmetic operations, or any other computing operation further described herein. In at least one embodiment, one or more computing operations using accelerator(s) 730 can include at least one or more groups of computing operations to be accelerated by execution at least in part by accelerator(s) 730, including to generate bounding functions for a mask predicate, generate instructions to skip computation with respect to masked portions an attention matrix, and/or otherwise perform any of the operations described herein.

In at least one embodiment, system 700 can be used to perform one or more instructions that include functions or operations, such as those described in connection with FIGS. 1-6. In at least one embodiment, system 700 including one or more processors causes one or more circuits to generate at least one 3D segmentation mask of a 3D mesh of an object and/or otherwise perform operations described herein. In at least one embodiment, system 700 is included in and/or otherwise includes systems illustrated in FIGS. 1-6 to cause one or more circuits to generate at least one 3D segmentation mask of a 3D mesh of an object and/or otherwise perform operations described herein. In at least one embodiment, system 700 includes one or more hardware illustrated in FIGS. 9A-11 such as to generate at least one 3D segmentation mask of a 3D mesh of an object and/or otherwise perform operations described herein.

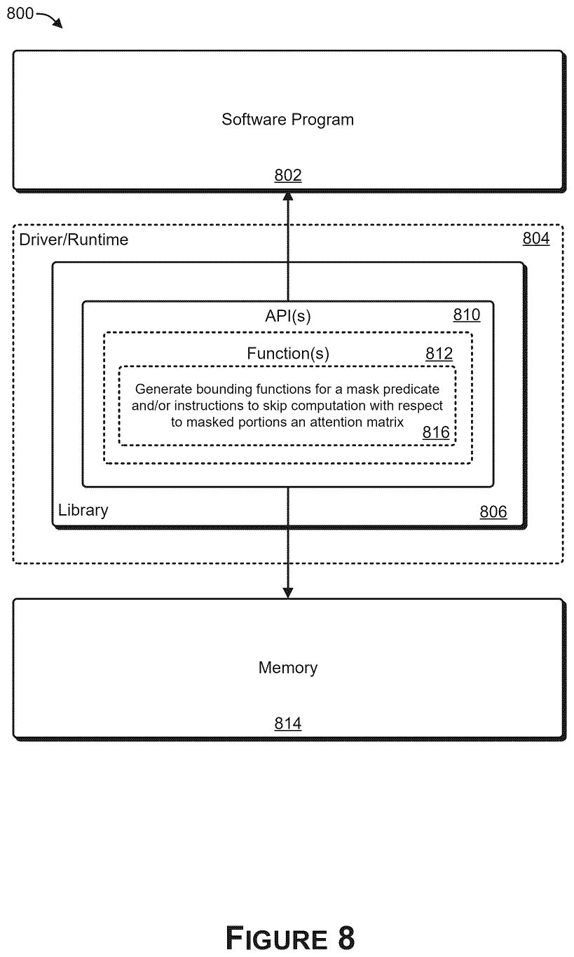

FIG. 8 is a block diagram 800 illustrating a driver and/or runtime including one or more libraries to provide one or more application programming interfaces (APIs), according to at least one embodiment. In at least one embodiment, a software program 802 is a software module. In at least one embodiment, a software program 802 includes one or more software modules. In at least one embodiment, one or more APIs 810 are sets of software instructions that, if executed, cause one or more processors to perform one or more computational operations. In at least one embodiment, one or more APIs 810 are distributed or otherwise provided as a part of one or more libraries 806, runtimes 804, drivers 804, and/or any other grouping of software and/or executable code further described herein. In at least one embodiment, one or more APIs 810 perform one or more computational operations in response to invocation by software programs 802. In at least one embodiment, a software program 802 is a collection of software code, commands, instructions, or other sequences of text to instruct a computing device to perform one or more computational operations and/or invoke one or more other sets of instructions, such as APIs 810 or API functions 812, to be executed.

In at least one embodiment, API functions 812 included but are not limited function to verify whether objects indicated in a description of an image are depicted in said image, functions to generate a textual description of visual content, functions to accept a natural language prompt to parse, edit, modify, and/or alter a description of an image, functions to identify whether objects descripted in a caption are depicted in an image sought to be described, and functions to generate an evaluation metric of a degree of similarity between an input image sought to be captioned and a generated caption. In at least one embodiment, functionality provided by one or more APIs 810 include software functions 812, such as those usable to accelerate one or more portions of software programs 802 using one or more parallel processing units (PPUs), such as graphics processing units (GPUs). In at least one embodiment, a software program is a compiler.

In at least one embodiment, APIs 810 are hardware interfaces to one or more circuits to perform one or more computational operations. In at least one embodiment, one or more software APIs 810 described herein are implemented as one or more circuits to perform one or more techniques described in conjunction with FIGS. 1-7. In at least one embodiment, one or more software programs 802 includes instructions that, if executed, cause one or more hardware devices and/or circuits to perform one or more techniques further described in conjunction with FIG. 1-7.

In at least one embodiment, software programs 802, such as user-implemented software programs, utilize one or more application programming interfaces (APIs) 810 to perform various computing operations, such as memory reservation, matrix multiplication, arithmetic operations, or any computing operation performed by parallel processing units (PPUs), such as graphics processing units (GPUs), as further described herein. In at least one embodiment, one or more APIs 810 provide a set of callable functions 812, referred to herein as APIs, API functions, and/or functions, that individually perform one or more computing operations, such as computing operations related to parallel computing. In at least one embodiment, one or more APIs 810 provide functions 812 to adjusting a description of an image. In at least one embodiment, one or more APIs 810 provide functions 812 to cause a neural network to perform one or more operations, such as by returning a called function to a processor where said processor invokes said neural network. In at least one embodiment, one or more APIs 810 provide functions to generate bounding functions for a mask predicate, generate instructions to skip computation with respect to masked portions the attention matrix 816, and/or otherwise perform any of the operations described herein.

In at least one embodiment, one or more software programs 802 interact or otherwise communicate with one or more APIs 810 to perform one or more computing operations using one or more PPUs, such as GPUs. In at least one embodiment, one or more computing operations using one or more PPUs include at least one or more groups of computing operations to be accelerated by execution at least in part by said one or more PPUs. In at least one embodiment, one or more software programs 802 interact with one or more APIs 810 to facilitate parallel computing using a remote or local interface.

In at least one embodiment, an interface is software instructions that, if executed, provide access to one or more functions 812 provided by one or more APIs 810. In at least one embodiment, a software program 802 uses a local interface when a software developer compiles one or more software programs 802 in conjunction with one or more libraries 806 including or otherwise providing access to one or more APIs 810. In at least one embodiment, one or more software programs 802 are compiled statically in conjunction with pre-compiled libraries 806 or uncompiled source code including instructions to perform one or more APIs 810. In at least one embodiment, one or more software programs 802 are compiled dynamically and said one or more software programs utilize a linker to link to one or more pre-compiled libraries 806 including one or more APIs 810.

In at least one embodiment, a software program 802 uses a remote interface when a software developer executes a software program that utilizes or otherwise communicates with a library 806 including one or more APIs 810 over a network or other remote communication medium. In at least one embodiment, one or more libraries 806 including one or more APIs 810 are to be performed by a remote computing service, such as a computing resource services provider. In another embodiment, one or more libraries 806 including one or more APIs 810 are to be performed by any other computing host providing said one or more APIs 810 to one or more software programs 802.

In at least one embodiment, a processor performing or using one or more software programs 802 calls, uses, performs, or otherwise implements one or more APIs 810 to allocate and otherwise manage memory to be used by said software programs 802. In at least one embodiment, one or more software programs 802 utilize one or more APIs 810 to allocate and otherwise manage memory to be used by one or more portions of said software programs 802 to be accelerated using one or more PPUs, such as GPUs or any other accelerator or processor further described herein. Those software programs 802 to generate bounding functions for a mask predicate, generate instructions to skip computation with respect to masked portions an attention matrix, and/or otherwise perform any of the operations described herein.

In at least one embodiment, an API 810 is an API to facilitate parallel computing. In at least one embodiment, an API 810 is any other API further described herein. In at least one embodiment, an API 810 is provided by a driver and/or runtime 804. In at least one embodiment, an API 810 is provided by a CUDA user-mode driver. In at least one embodiment, an API 810 is provided by a CUDA runtime. In at least one embodiment, a driver 804 is data values and software instructions that, if executed, perform or otherwise facilitate operation of one or more functions 812 of an API 810 during load and execution of one or more portions of a software program 802. In at least one embodiment, a runtime 804 is data values and software instructions that, if executed, perform or otherwise facilitate operation of one or more functions 812 of an API 810 during execution of a software program 802. In at least one embodiment, one or more software programs 802 utilize one or more APIs 810 implemented or otherwise provided by a driver and/or runtime 804 to perform combined arithmetic operations by said one or more software programs 802 during execution by one or more PPUs, such as GPUs.

In at least one embodiment, one or more software programs 802 utilize one or more APIs 810 provided by a driver and/or runtime 804 to perform combined arithmetic operations of one or more PPUs, such as GPUs. In at least one embodiment, one or more APIs 810 provide combined arithmetic operations through a driver and/or runtime 804, as described above. In at least one embodiment, one or more software programs 802 utilize one or more APIs 810 provided by a driver and/or runtime 804 to allocate or otherwise reserve one or more blocks of memory 814 of one or more PPUs, such as GPUs. In at least one embodiment, one or more software programs 802 utilize one or more APIs 810 provided by a driver and/or runtime 804 to allocate or otherwise reserve blocks of memory. In at least one embodiment, one or more APIs 810 are to perform combined arithmetic operations, as described below in conjunction with any FIGS. 1-7.

To improve software programs 802 usability and/or optimization of one or more portions of said software programs 802 to be accelerated by one or more PPUs, such as GPUs, in an embodiment, one or more APIs 810 provide one or more API functions 812 to perform a software correction system usable or used by one or more computing devices as described above and further described in conjunction with FIGS. 1-7. In at least one embodiment, a block diagram 800 depicts a processor, including one or more circuits to perform one or more software programs to combine two or more application programming interfaces (APIs) into a single API. In at least one embodiment, a block diagram 800 depicts a system, including one or more processors to perform one or more software programs to combine two or more application programming interfaces (APIs) into a single API.

In at least one embodiment, at least a portion of block diagram 800 is implemented using at least a portion of any system(s) depicted in and/or described with respect to FIGS. 9A-11. In at least one embodiment, block diagram 800 is performed by processor(s) 104 of FIG. 1. In at least one embodiment, at least a portion of block diagram 800 is used to implement at least a portion of any system(s) depicted in and/or described with respect to FIGS. 9A-11.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)-such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms-may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models- or layers thereof-may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 930 (e.g., LLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/VLM/MMLM/etc. with external knowledge, so that answers to specific questions or queries or requests are more relevant—such as in a case where specific knowledge is required. The RAG component 992 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 905 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 905 may resample an audio file to a consistent sampling rate for uniform processing, and the embedding component 920 may use any known technique to extract and encode audio features—such as in the form of a spectrogram (e.g., a mel-spectrogram). In some implementations in which the input 901 includes video data, the input processor 905 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use- or capable of accessing or using-plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated—e.g., recursively—for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources-such as the plug-ins/APIs 995.

FIG. 9B is a block diagram of an example implementation in which the generative LM 930 includes a transformer encoder-decoder. For example, assume input text such as “Who discovered gravity” is tokenized (e.g., by the tokenizer 910 of FIG. 9A) into tokens such as words, and each token is encoded (e.g., by the embedding component 920 of FIG. 99A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation component(s) 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R. s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R. s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may use distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

At least one embodiment of the disclosure can be described in view of the following clauses:

Clause 1. One or more processors comprising processing circuitry to: implement a compiler to generate instructions that, when executed by at least one processor, cause the at least one processor to skip computation of one or more masked values in one or more masked portions of at least one data structure representing one or more attention matrices that are masked by a mask predicate, the compiler generating the instructions by at least: deriving a plurality of elements based at least on the mask predicate; determining pairs of upper and lower bounding expressions corresponding to the plurality of elements; generating left and right bounding functions using the pairs of upper and lower bounding expressions corresponding to the plurality of elements; and using the left and right bounding functions to generate the instructions.

Clause 2. The one or more processors of clause 1, wherein the mask predicate is an arbitrary mask predicate provided by a user.

Clause 3. The one or more processors of clause 1 or 2, wherein upper and lower bounding expressions in each of the pairs of upper and lower bounding expressions are affine expressions that bound one or more elements representing unmasked portions of the at least one data structure representing the one or more attention matrices defined by the mask predicate, and when executed by the one or more processors, the instructions are to cause the at least one processor to perform one or more computations during runtime with respect to the one or more unmasked portions.

Clause 4. The one or more processors of any one of clauses 1-3, wherein the plurality of elements derived based at least on the mask predicate comprises at least first and second comparisons linked by a logical operator, and the first and second comparisons are combined differently depending on whether the logical operator is a logical AND operator or a logical OR operator.

Clause 5. The one or more processors of clause 4, wherein AND max/min logic is used to combine the first and second comparisons when the logical operator is a logical AND operator, and OR max/min logic is used to combine the first and second comparisons when the logical operator is a logical OR operator.

Clause 6. The one or more processors of clause 4 or 5, wherein one or more unmasked portions comprise one or more unmasked tiles each corresponding to a plurality of values in a particular data structure of the at least the data structure representing a particular one of the one or more attention matrices, and the at least one processor processes the plurality of values in an unmasked tile of the one or more unmasked tiles in parallel.

Clause 7. The one or more processors of any one of clauses 1-6, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more small language models (SLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

Clause 8. A system comprising one or more processors to: generate one or more bounding functions based at least on one or more mask predicates; and use the one or more bounding functions to generate instructions to cause at least one processor to skip computation of one or more first values corresponding to one or more first portions of at least one data structure representing one or more attention matrices.

Clause 9. The system of clause 8, wherein the one or more bounding functions comprise monotonic bounding functions that define a left-most valid column and a right-most valid column in each row in the one or more attention matrices represented by the at least one data structure.

Clause 10. The system of clause 8 or 9, wherein the one or more processors are to: use an element to at least partially define the at least one or more mask predicates; and generate a pair of affine expressions that bound the element, wherein the one or more bounding functions are generated based at least on the pair of affine expressions.

Clause 11. The system of any one of clauses 8-10, wherein the at least one or more mask predicates comprise a plurality of comparisons combined by at least one logical operator, and the one or more processors are to: determine pairs of upper and lower bounding expressions corresponding to the plurality of comparisons; and generate the one or more bounding functions using the pairs of upper and lower bounding expressions corresponding to the plurality of comparisons.

Clause 12. The system of any one of clauses 8-11, wherein the instructions cause the at least one processor to calculate one or more second values corresponding to one or more second portions of the at least one data structure representing the one or more attention matrices, the one or more first portions and the one or more second portions are mutually exclusive.

Clause 13. The system of clause 12, wherein the one or more first portions and the one or more second portions comprise one or more tiles each representing more than one value in a particular data structure the at least one data structure representing a particular one of the one or more attention matrices.

Clause 14. The system of any one of clauses 8-13, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more small language models (SLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

Clause 15. A method comprising: generating, by a compiler implemented by one or more processors, one or more bounding functions based at least on a mask predicate; using, by the compiler, the one or more bounding functions to identify one or more masked tiles and one or more unmasked tiles of a plurality of tiles within a data structure; and generating, by the compiler, instructions to cause at least one processor to perform at least one computation with respect to the one or more unmasked tiles, and to skip computation with respect to the one or more masked tiles.

Clause 16. The method of clause 15, wherein the one or more bounding functions comprise monotonic bounding functions that define a left-most valid column and a right-most valid column in each row of the data structure.

Clause 17. The method of clause 15 or 16, further comprising: using, by the compiler, an element to at least partially define the mask predicate; generating, by the compiler, a pair of affine expressions that bound the element; and using, by the compiler, the pair of affine expressions to generate the one or more bounding functions.

Clause 18. The method of any one of clauses 15-17, wherein the mask predicate comprises a plurality of comparisons combined by at least one logical operator, and the compiler generates the one or more bounding functions by at least: determining pairs of upper and lower bounding expressions corresponding to the plurality of elements in comparisons; and combining comparison bounding functions derived from the pairs of upper and lower bounding expressions.

Clause 19. The method of any one of clauses 15-18, further comprising generating, by the compiler a kernel comprising the instructions to be executed by one or more graphics processing units (“GPUs”).

Clause 20. The method of any one of clauses 15-19, wherein the method is performed by at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more small language models (SLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
implement a compiler to generate instructions that, when executed by at least one processor, cause the at least one processor to skip computation of one or more masked values in one or more masked portions of at least one data structure representing one or more attention matrices that are masked by a mask predicate, the compiler generating the instructions by at least:
deriving a plurality of elements based at least on the mask predicate;
determining pairs of upper and lower bounding expressions corresponding to the plurality of elements;
generating left and right bounding functions using the pairs of upper and lower bounding expressions corresponding to the plurality of elements; and
using the left and right bounding functions to generate the instructions.

2. The one or more processors of claim 1, wherein the mask predicate is an arbitrary mask predicate provided by a user.

3. The one or more processors of claim 1, wherein upper and lower bounding expressions in each of the pairs of upper and lower bounding expressions are affine expressions used in comparisons that bound one or more unmasked portions of the at least one data structure representing the one or more attention matrices defined by the mask predicate, and
when executed by the one or more processors, the instructions cause the at least one processor to perform one or more computations during runtime with respect to the one or more unmasked portions.

4. The one or more processors of claim 1, wherein the plurality of elements derived based at least on the mask predicate comprised at least first and second comparisons linked by a logical operator, and
the first and second comparisons are combined differently depending on whether the logical operator is a logical AND operator or a logical OR operator.

5. The one or more processors of claim 4, wherein AND max/min logic is used to combine the first and second comparisons when the logical operator is a logical AND operator, and
OR max/min logic is used to combine when first and second comparisons if the logical operator is a logical OR operator.

6. The one or more processors of claim 5, wherein one or more unmasked portions comprise one or more unmasked tiles each corresponding to a plurality of values in a particular data structure of the at least one data structure representing a particular one of the one or more attention matrices, and the at least one processor processes the plurality of values in an unmasked tile of the one or more unmasked tiles in parallel.

7. The one or more processors of claim 1, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more small language models (SLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

8. A system comprising one or more processors to:
generate one or more bounding functions based at least on one or more mask predicates; and
use the one or more bounding functions to generate instructions to cause at least one processor to skip computation of one or more first values corresponding to one or more first portions of at least one data structure representing one or more attention matrices.

9. The system of claim 8, wherein the one or more bounding functions comprise monotonic bounding functions that define a left-most valid column and a right-most valid column in each row in the one or more attention matrices represented by the at least one data structure.

10. The system of claim 8, wherein the one or more processors are to:
use an element to at least partially define the at least one or more mask predicates; and
generate a pair of affine expressions that bound the element, wherein the one or more bounding functions are generated based at least on the pair of affine expressions.

11. The system of claim 8, wherein the at least one or more mask predicates comprise a plurality of comparisons combined by at least one logical operator, and the one or more processors are to:
determine pairs of upper and lower bounding expressions corresponding to the plurality of comparisons; and
generate the one or more bounding functions using the pairs of upper and lower bounding expressions corresponding to the plurality of comparisons.

12. The system of claim 8, wherein the instructions cause the at least one processor to calculate one or more second values corresponding to one or more second portions of the at least one data structure representing the one or more attention matrices, the one or more first portions and the one or more second portions are mutually exclusive.

13. The system of claim 12, wherein the one or more first portions and the one or more second portions comprise one or more tiles each representing more than one value in a particular data structure the at least one data structure representing a particular one of the one or more attention matrices.

14. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more small language models (SLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

15. A method comprising:
generating, by a compiler implemented by one or more processors, one or more bounding functions based at least on a mask predicate;
using, by the compiler, the one or more bounding functions to identify one or more masked tiles and one or more unmasked tiles of a plurality of tiles within a data structure; and
generating, by the compiler, instructions to cause at least one processor to perform at least one computation with respect to the one or more unmasked tiles, and to skip computation with respect to the one or more masked tiles.

16. The method of claim 15, wherein the one or more bounding functions comprise monotonic bounding functions that define a left-most valid column and a right-most valid column in each row of the data structure.

17. The method of claim 15, further comprising:
using, by the compiler, an element to at least partially define the mask predicate;
generating, by the compiler, a pair of affine expressions that bound the element; and
using, by the compiler, the pair of affine expressions to generate the one or more bounding functions.

18. The method of claim 15, wherein the mask predicate comprises a plurality of comparisons combined by at least one logical operator, and the compiler generates the one or more bounding functions by at least:
determining pairs of upper and lower bounding expressions corresponding to the plurality of comparisons; and
combining comparison bounding functions derived from the pairs of upper and lower bounding expressions.

19. The method of claim 15, further comprising generating, by the compiler, a kernel comprising the instructions to be executed by one or more graphics processing units (“GPUs”).

20. The method of claim 15, wherein the method is performed by at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more small language models (SLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
